(19) United States
(12) Patent Application Publication
(10) Pub. No.: US 2007/0256573 A1
(43) Pub. Date: Nov. 8, 2007

(54) Container And A Mechanism For Submerging A Food Substance Into A Liquid

(76) Inventor: Justin W. Lemley, Morgantown, WV (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/743,841

(22) Filed: May 3, 2007

Related U.S. Application Data
(60) Provisional application No. 60/797,314, filed on May 3, 2006.

(51) Int. Cl. A23B 4/02

(52) U.S. Cl. 99/494

(57) ABSTRACT

A container, e.g., a container, cup, drinking glass, includes a mechanism for allowing a user to submerge a good substance, e.g., cookie into a liquid, e.g., milk. The mechanism has a spring-based frame with spaced-apart plates and a tab connected to the frame. The food substance is placed between the plates and the tab is pushed downwardly forcing the frame against a spring assembly and immersing the food substance into the liquid. Release of the tab releases the energy of the spring assembly to quickly raise the frame and the food substance out of the liquid. The mechanism may be an integral part of the container or it may be a removable unit. Since there are no loose parts to the mechanism, the user may drink the remaining liquid in the container after eating the food substance.

### CROSS REFERENCE TO RELATED APPLICATION

This application claims the benefit of U.S. Provisional Application No. 60/797,314, filed May 3, 2006 and which is hereby incorporated by reference in its entirety.

### BACKGROUND OF THE INVENTION

1. Field of the Invention

The invention relates to a mechanism for submerging a food substance, e.g., cookies into a liquid, e.g., milk; a container for holding a liquid and including the mechanism; and to a method for submerging a food substance into a liquid and quickly retrieving it for purposes of eating it.

2. Description of the Prior Art

Most of the general public at one time or the other has delighted in submerging or dunking a food substance, such as a cookie into a liquid, such as milk, coffee, tea and hot chocolate, so that the liquid soaks into the food substance prior to eating the food substance. This experience has been that, for example, if the food substance is a cookie and if it remains in the liquid too long, the cookie crumbles. Additionally, since the cookie is held between the fingers of the human, occasionally the fingers become submerged in the liquid, thereby requiring the fingers to be cleaned. If the liquid is too hot, such as coffee or hot chocolate, or if the liquid is too cold, a further disadvantage is that the fingers are subjected to this temperature, which in some instances, makes the submerging or dunking of a cookie an unpleasant experience.

There is a need therefore to provide a mechanism and/or a container including a mechanism for submerging or dunking a food substance, for example, a cookie, into a liquid, for example, milk, coffee tea and hot chocolate, without the user's fingers coming into contact with the liquid.

There is a further need in the art to provide a mechanism and/or a container including a mechanism for submerging or dunking a food substance into a liquid and quickly retrieving it before it has a chance to crumble in the liquid.

### SUMMARY OF THE INVENTION

The invention provides a container, for example, a cup, container or drinking glass for holding a liquid, e.g., milk, coffee, tea or hot chocolate, which includes a mechanism designed to allow the user to insert or dunk a food substance, e.g., a cookie, into the liquid by depressing a tab of the mechanism, and then releasing the tab so that the food substance is raised out of the liquid. This allows the user the experience of dunking the food substance without putting his or her fingers into the container and/or liquid. The container and the mechanism in the container are user friendly for both children and adults, giving both a fun and more efficient method for submerging or dunking food substances into a liquid.

One embodiment of the invention relates to a container for holding a liquid and includes a mechanism for submerging a food substance into the liquid and quickly retrieving the food substance for purposes of eating the food substance. The mechanism includes a spring-loaded frame for supporting the food substance and an attached tab. The frame is configured to be depressed and moved in a first direction into the liquid upon operation of the tab and to be moved in a second direction out of the liquid upon release of the tab. The mechanism also includes a shaft assembly connected to the frame and to the container, and has a first member movable within a second member and a spring assembly in the first member and the second member. The frame includes at least two spaced-apart plates for supporting the food substance therebetween. The spaced-apart plates are made of a mesh material for allowing the liquid to contact the food substance, are movable relative to each other and are connected together along one of their lengths by way of at least one spring. The mechanism may be an integral part of the container wherein the shaft assembly may be embedded into the bottom of the container, or the mechanism may be a removable unit wherein the shaft assembly is connected to a base which is not part of the container. In this latter instance, the entire unit may be inserted into and removed from the container for easy cleaning and for use in another container.

A further embodiment of the invention relates to a mechanism for submerging a food substance into a liquid in a container including a spring-loaded frame for supporting the food substance and an attached tab. The frame is configured to be depressed and moved in a first direction into the liquid upon operation of the tab and to be moved in a second direction out of the liquid upon release of the tab. The mechanism further includes a shaft assembly having a first member movable within a second member and a spring assembly in the first member and the second member and connected to the frame and to the container. The frame includes at least two spaced-apart plates for supporting the food substance therebetween. The spaced-apart plates are made of a mesh material for allowing the liquid to contact the food substance, are movable relative to each other and are connected together along one of their lengths by way of at least one spring. The mechanism may be an integral part of the container wherein the shaft assembly is embedded into the bottom of the container or the mechanism may be a removable unit wherein the shaft assembly is connected to a base which is not part of the container. In this latter instance, the entire unit may be inserted into and removed from the container for easy cleaning and for use in another container.

A still further embodiment of the invention relates to a method for submerging a food substance into a liquid and quickly retrieving the food substance for purposes of eating the food substance. The steps include providing a mechanism having a spring-loaded frame for supporting the food substance and an attached tab, operating the tab so that the spring-loaded frame with the food substance moves in a first direction into the liquid and releasing the tab so that the spring-loaded frame with the food substance moves in a second direction out of the liquid.

It is therefore an object of the present invention to provide a mechanism which allows a user to easily submerge a food substance into a liquid in a container and to quickly retrieve it.

It is a further object of the invention to provide a mechanism for submerging a food substance into a liquid, which mechanism can fit into a container of a variety of sizes and which mechanism can easily accommodate any size and/or shape of food substance.

These and other objects, features and advantages of the invention will become more apparent upon consideration of the following description with reference to the accompanying drawings, all of which form a part of this specification, wherein like reference numerals designate corresponding parts in the various figures.

### BRIEF DESCRIPTION OF THE DRAWINGS

FIG. 1 is a side elevational view of a container showing a partial view of a submerging mechanism constructed in accordance with the teachings of the invention;

FIG. 2 is a cross-sectional view of the container of FIG. 1 showing in more detail a submerging mechanism of a first embodiment of the invention;

FIG. 3 is a cross-sectional partial view showing a shaft member of the submerging mechanism of FIG. 2;

FIG. 3A is an enlarged, partial cross-section view illustrating in detail the connection between the two pieces of the shaft member of FIG. 3;

FIG. 4 is a top elevational view of the container and the submerging mechanism of FIGS. 1 and 2;

FIG. 5 is a cross-sectional view of the container of FIG. 1 showing in more detail a submerging mechanism of a second embodiment of the invention;

FIG. 6 is a top elevational view of the container and the submerging mechanism of FIGS. 1 and 5; and

FIG. 7 is a cross-sectional view of the container of FIG. 1 showing a submerged mechanism of a third embodiment of the invention.

### DESCRIPTION OF THE INVENTION

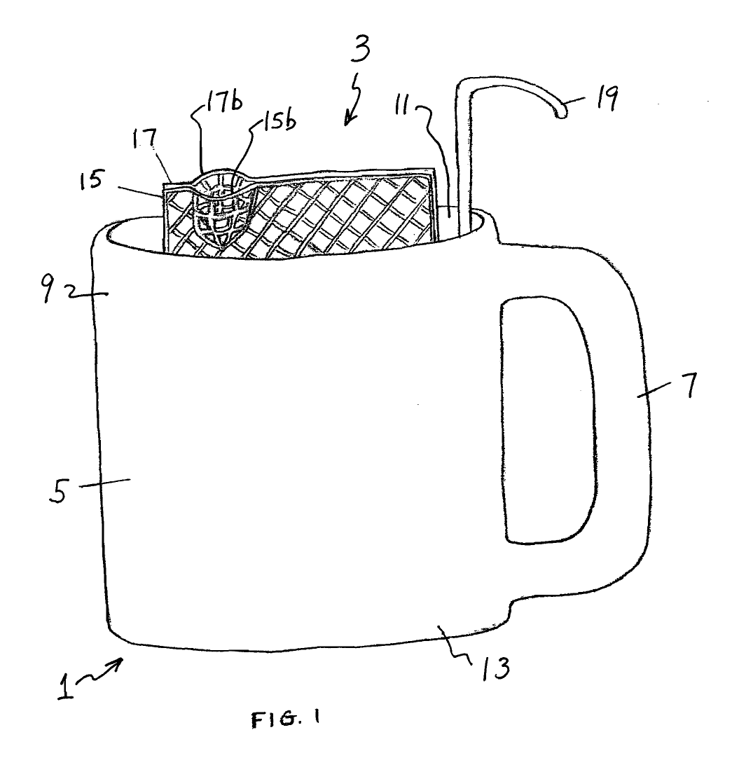

FIG. 1 shows a container 1 and a partial view of a mechanism 3 for submerging a food substance (not shown). In this FIG. 1, container 1 is a cup or container, but container 1 may be a drinking glass or any other kind of container which holds liquid. As stated hereinabove, the food substance may be a cookie and the liquid may be milk, coffee, tea or hot chocolate. However, the food substance may be any type of food which can be submerged in a liquid and the liquid may be other than those listed.

Still referring to FIG. 1, container 1 has a body 5 and a handle 7. Body 5 has an outer shell 9, an opening 11 for receiving mechanism 3 and a bottom 13. The body 5 and handle 7 may be constructed of a rigid material, such as a hard-molded material, e.g., plastic (similar commercially available mugs). The top of container 1 illustrates a mechanism 3 sticking out of its opening 11. In this FIG. 1, mechanism 3 has two plates 15, 17 and a tab 19 connected to a frame 21, which can be used to lower mechanism 3 down into container 1, more about which is discussed hereinbelow.

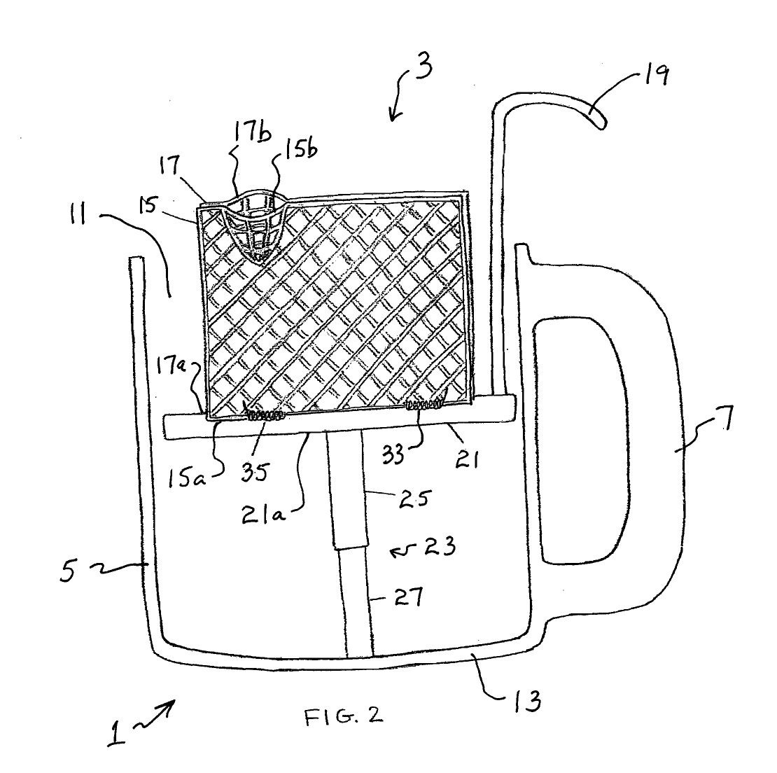

FIG. 2 best illustrates the components of mechanism 3. In addition to the two plates 15, 17 and the tab 19, mechanism 3 also includes the frame 21 for supporting the plates 15, 17 and tab 19 connected to the frame 21, and a shaft assembly 23 for supporting the frame 21 in the container 1. Shaft assembly 23 includes an upper member 25 and a lower member 27 which houses a spring assembly (not shown). The tab 19 is connected to the frame 21. These members 25 and 27 are concentrically arranged, with lower member 27 having a diameter that is less than the diameter of upper member 25, thereby allowing lower member 27 to be movable within upper member 25. Lower member 27 is connected to an inner surface of the bottom 13 of container 1 and the upper member 25 of shaft assembly 23 is connected to an undersurface 21a of frame 21. Preferably, upper member 25 and lower member 27 are constructed of a hard plastic. Upper member 25 can be bonded to the undersurface 21a of frame 21 and lower member 27 is bonded to the inner surface at the bottom 13 of container 1, and the bonding would be such that it prevents liquid penetration. The upper member 25 and/or the lower member 27 may have some lateral flexibility to minimize stress of the shaft assembly 23 connected to the bottom 13 of the container 1. It is to be appreciated however that lower member 27 can be affixed to container 1 via a number of suitable means known to those skilled in the art or it can be an integral part of container 1 formed in the same molding process for forming container 1. In this latter instance, it is apparent that the other components of mechanism 3 can then be assembled in a manner which is obvious based on the teachings of the invention.

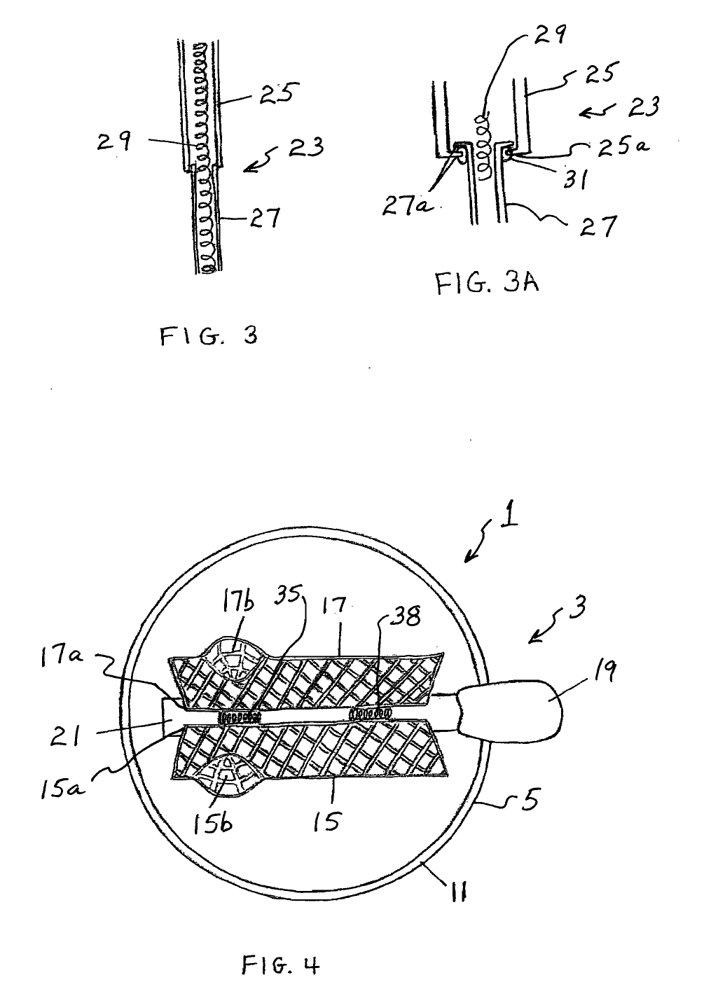

FIGS. 3 and 3A show a spring assembly 29 extending in upper member 25 and lower member 27 of the shaft assembly 23. It is to be appreciated that the existence of spring assembly 29 within the shaft assembly 23 and the connection of the shaft assembly 23 to frame 21 results in frame 21 being spring loaded. Spring assembly 29 is in an extended position in FIG. 3 which, in effect, disposes mechanism 3 in a raised position.

FIG. 3A best illustrates the connection between the upper member 25 and lower member 27 of shaft assembly 23. Liquid is kept out of these elements 25, 27 by a rubber gasket 31 which is connected to a lip 25a of upper member 25. FIG. 3A shows lip 27a of lower member 27 contacting gasket 31. Members 25, 27 are kept intact when these members are fully extended as shown in FIG. 3A via the engagement of lip 27a against gasket 31 and lip 25a of lower member 25. When the depressible tab 19 is depressed or forced downwardly into container 1, since tab 19 is connected to plate 21, plate 21 is moved in the same direction forcing spring assembly 29 to be compressed as the upper member 25 of shaft assembly 23 slides down over lower member 27.

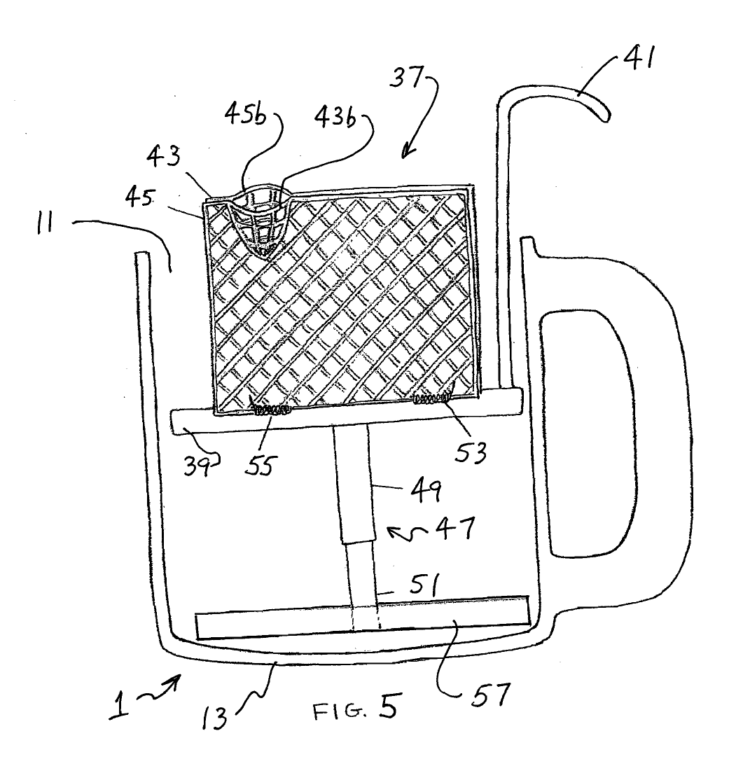

FIG. 4 best illustrates the construction of plates 15, 17 on frame 21. Plates 15, 17 are constructed to hold a food substance, such as a cookie, therebetween. These plates 15, 17 are spaced apart and are connected along one of their lengths 15a, 17a by reverse-clamping springs 33, 35 which are attached to the upper surface of frame 21. Preferably, these springs 33, 35 are made of metal and are silicon coated in order to prevent the metal from coming into contact with any liquid in container 1. Plates 15, 17 in FIG. 4 are shown as having a screen with a waffle texture. This type of screen allows the liquid to saturate the food substance for a desired amount of time as determined by the user of container 1. Preferably plates 15, 17 are made of hard rigid plastic, but can also be made of a flexible material. On the top of each plate 15, 17 directly across from one another are a finger-sized indention 15b, 17b, which allows the user to grasp and spread the two plates 15, 17 apart with his/her fingers for the insertion of a food substance between plates 15, 17. Plates 15, 17 preferably are of a dimension such that plates 15, 17 may accommodate food substances having different sizes and shapes.

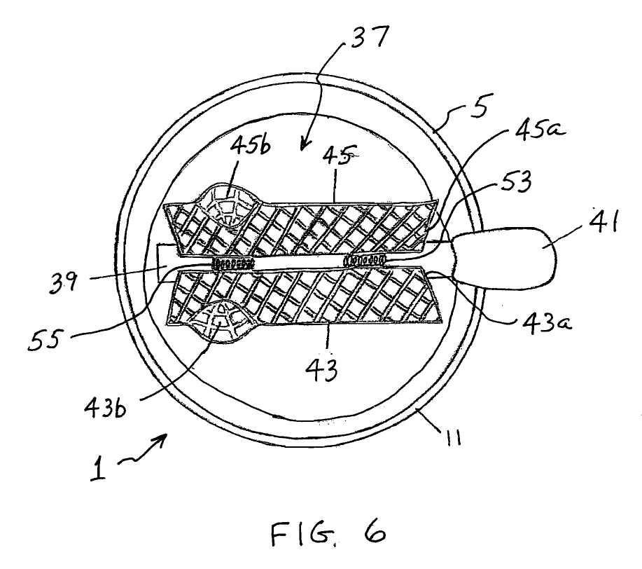

FIGS. 5 and 6 illustrate a second embodiment for a mechanism 37 for submerging a food substance in a liquid. This mechanism 37 in container 1 has plates, a frame 39 and a tab 41. Frame 39 includes two plates 43, 45 and a shaft assembly 47 which have an upper member 49, a lower member 51, and a spring assembly (not shown) extends in upper member 49 and lower member 51 similar to that shown in FIGS. 3 and 3A for mechanism 3. Plates 43, 45 are spaced apart on frame 39 and are connected together along their lengths 43a, 45a by two reverse-clamping springs attached to the upper surface of frame 39. On the top of each plate 43, 45 directly across from one another are finger-sized indentions 43b, 45b which allow the user to grasp and spread the two plates 43, 45 apart with his/her fingers for the insertion of the food substance between plates 43, 45.

This mechanism 37 of FIGS. 5 and 6 is similar in construction, material and operation to that of mechanism 3 in FIGS. 1-4 except that the lower member 51 of the shaft assembly 47 is attached to a base member 57. Preferably, lower member 51 is bonded to the upper surface of base member 57; however, it can be attached to base member 57 via a number of ways to those skilled in the art. For example, lower member 51 may be molded and made an integral part of base member 57 during the molding process.

As best shown in FIG. 5, base member 57 is apart from frame 39. Preferably base member 57 is a disc with a diameter that would be less than the diameter of container 1. An advantage of this structure for mechanism 37 is that it is removable, can be used in other containers and is not strictly limited for use in one container which may be the instance for the embodiment shown particularly in FIG. 2. The size of base member 57 would also be such that it would be able to fit into containers of a variety of sizes.

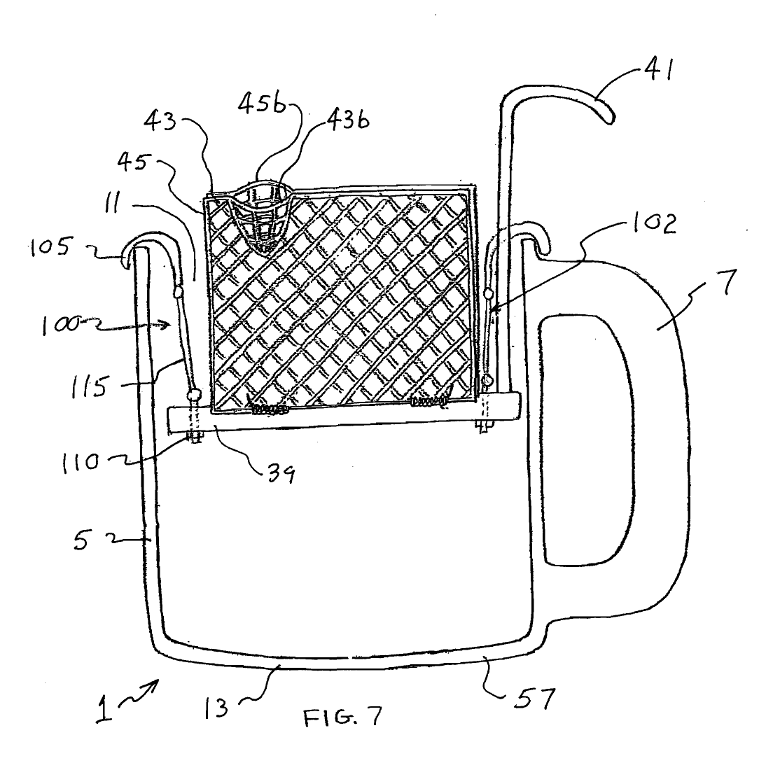

FIG. 7 illustrates an arrangement similar to the arrangement in FIG. 5, but without the shaft assembly 47. Instead, the frame 39 is resiliently supported from the handle 7 of the container body 5 by a resilient element 100, which is identical to an element 102, has a hook 105 which engages an edge of the container 1 and an anchor 110, which is secured to the frame 39. A resilient connector 115 connects the hook 105 and the anchor 110. Now, the tab 41 may be depressed and the resilient elements 100, 102 offer resistance.

31 The operation of the invention will now be described with reference to the mechanism 3. In operation, container 1 is first filled to a desired level with a liquid. The user can then separate plates 15, 17 by pushing apart the two plates with his/her fingers, using the indented spaces 15b, 17b. The user then places a food substance, such as a cookie, between plates 15, 17 and releases them, allowing plates 15, 17 to hold the cookie. Because the plates 15, 17 are operated by springs 33, 35 and are open-ended, the space between plates 15, 17 away from the springs 33, 35 is adjustable thereby allowing for food substances of different shapes and sizes to be inserted there between.

Once plates 15, 17 are operated to hold a food substance, the user can depress the tab 19 downwardly to submerge the food substance into the liquid in container 1. Since tab 19 and frame 21 are connected together, frame 21 moves downwardly with tab 19 into the liquid upon operation of tab 19. Frame 21 forces spring assembly 29 to be compressed. Because tab 19 and frame 21 with plates 15, 17 are spring-loaded via shaft assembly 23 and spring assembly 29, the user can decide how far the food substance is to be submerged into the liquid. Once the chosen duration of submersion is reached, the user can release the tab 19, which releases the energy in spring assembly 29, thereby extending spring assembly 29 and raising frame 21 with plates 15, 17 out of container 1 to the original positioning of mechanism 3 in container 1 as shown particularly in FIG. 1. Also, since the frame 21 is spring-loaded, release of tab 19 allows frame 21 with plates 15, 17 to be quickly raised out of the liquid. The user then separates plates 15, 17, once again using the indented spaces 15b, 17b, and removes the food substance from between plates 15, 17.

As stated hereinabove, operation of mechanism 37 is similar to that described in the preceding paragraph for mechanism 3. In this instance, mechanism 37 is first inserted into the container 1, and the same procedure is used as described in the preceding paragraph for mechanism 3. As can be appreciated, mechanisms 3 and 37 result in an approach to dunking a food substance, such as a cookie, into a liquid, such as milk, that does not involve the user's fingers and hands getting into the liquid. It is to be appreciated that the energy in spring assembly 29 and in resilient connector 115 (FIG. 7) is such that release of tabs 19, 41 allows the mechanisms 3, 37 to be retained in the container 1.

The present invention has been described with reference to the above embodiments. Obvious modifications and alterations will occur to others upon reading and understanding the preceding detailed description. It is intended that the invention be construed as including all such modifications and alterations.

The invention claimed is:

1. A container for holding a liquid, comprising:
a mechanism for submerging a food substance into a liquid and retrieving the food substance for purposes of eating the food substance.

2. The container of claim 1, wherein the mechanism comprises a spring-loaded frame for supporting the food substance and a tab, and
wherein the frame is configured to be moved in a first direction into the liquid upon operation of the tab and to be moved in a second direction out of the liquid upon release of the tab.

3. The container of claim 2, wherein the mechanism further comprises a resilient shaft assembly having a first member movable within a second member and a spring assembly in the first member and the second member, and
wherein the shaft assembly is connected to the frame of the mechanism and to the container.

4. The container of claim 2, wherein the frame comprises at least two spaced-apart plates for the supporting of the food substance therebetween.

5. The container of claim 4, wherein the two spaced-apart plates are made of a mesh material for allowing the liquid to contact the food substance.

6. The container of claim 5, wherein the two spaced-apart plates are movable relative to each other and are connected together along one of their lengths by way of at least one spring.

7. The container of claim 2, wherein the mechanism further comprises:
a base for supporting the mechanism in the container,
a resilient shaft assembly having a first member movable within a second member and a spring assembly in the first member and the second member, and
wherein the shaft assembly is connected to the frame of the mechanism and to the base of the mechanism.

8. The container of claim 7, wherein the frame comprises at least two spaced-apart plates for supporting the food substance therebetween.

9. The container of claim 8, wherein the two spaced-apart plates are made of a mesh material for allowing the liquid to contact the food substance.

10. The container of claim 9, wherein the two spaced-apart plates are movable relative to each other and are connected together along one of their lengths by way of at least one spring.

11. A mechanism for submerging a food substance into a liquid of a container, comprising:
a spring-loaded frame for supporting the food substance and a tab, and
wherein the frame is configured to be moved in a first direction into the liquid upon operation of the tab and to be moved in a second direction out of the liquid upon release of the tab.

12. The mechanism of claim 11, further comprising:
a resilient shaft assembly having a first member movable within a second member and a spring assembly in the first member and the second member, and
wherein the shaft assembly is connected to the frame of the mechanism and to the container.

13. The mechanism of claim 12, wherein the frame comprises at least two spaced-apart plates for supporting the food substance therebetween.

14. The mechanism of claim 13, wherein the two spaced-apart plates are made of a mesh material for allowing the liquid to contact the food substance.

15. The container of claim 14, wherein the two spaced-apart plates are movable relative to each other and are connected together along one of their lengths by way of at least one spring.

16. The mechanism of claim 11 further comprising:
a base for supporting the mechanism in the container; and
a resilient shaft assembly having a first member movable within a second member and a spring assembly in the first member and the second member, and
wherein the shaft assembly is connected to the frame of the mechanism and to the base of the mechanism.

17. The mechanism of claim 16, wherein the frame comprises at least two spaced-apart plates for supporting the food substance therebetween.

18. The mechanism of claim 17, wherein the two spaced-apart plates are made of a mesh material for allowing the liquid to contact the food substance.

19. The mechanism of claim 18, wherein the two spaced-apart plates are movable relative to each other and are connected together along one of their lengths by way of at least one spring.

20. A method for submerging a food substance into a liquid and retrieving the food substance for purposes of eating the food substance, the steps comprising:
providing a mechanism comprising a spring-loaded frame for supporting the food substance and a tab,
operating the tab so that the spring-loaded frame with the food substance moves in a first direction into the liquid, and
releasing the tab so that the spring-loaded frame with the food substance moves in a second direction out of the liquid.

21. The container of claim 1, further comprising resilient elements secured to the top of the container and to the frame.

22. The mechanism of claim 11, further comprising resilient elements secured to the top of the container and to the frame.
